(19) United States
(12) Patent Application Publication
(10) Pub. No.: US 2026/0227498 A1
(43) Pub. Date: Aug. 6, 2026

(54) Systems and Methods for Validating a LiDAR Processing Algorithm

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/373,700

(22) Filed: Oct. 29, 2025

Related U.S. Application Data
(63) Continuation-in-part of application No. 19/344,503, filed on Sep. 29, 2025.
(60) Provisional application No. 63/753,937, filed on Feb. 4, 2025.
(60) Provisional application No. 63/753,937, filed on Feb. 4, 2025.
(60) Provisional application No. 63/753,948, filed on Feb. 5, 2025.

(51) Int. Cl. G01S 7/497; G01S 17/89; G01S 17/931; G06F 30/20; G06F 119/10

(52) U.S. Cl. CPC G01S 7/497; G01S 17/89; G01S 17/931; G06F 30/20; G06F 2119/10

(57) ABSTRACT

A simulation system is disclosed for generating a validation point cloud for validating a lidar processing algorithm. It comprises a simulation digital storage medium comprising lidar data from a lidar sensor and a three-dimensional model of at least one object, wherein the lidar data comprises an origin and a point cloud; and a controller in communication with the simulation digital storage medium. The controller retrieves the lidar data and the model from the simulation digital storage medium, superimposes the model in the lidar data, traces a beam line from the origin to each point in the point cloud, each beam line collinear with a beam trajectory of a lidar beam which generated the respective point in the lidar data, identifies intersecting beam lines, defined as beam lines which intersect the model, and moves the respective point for each intersecting beam line to a surface of the model closest to the origin along the intersecting beam line to generate a validation point cloud comprising original points and moved points.

### BACKGROUND

LiDAR processing systems need to be tested for accuracy when they are developed. Some methods for testing LiDAR processing systems include using simulated environments, using recorded data from vehicles, or doing on-vehicle testing. However, each of these methods have some drawbacks, such as poor data fidelity with simulations or long set up times with recorded data or on-vehicle testing.

### SUMMARY

A simulation system for generating a validation point cloud for validating a lidar processing algorithm is disclosed. The simulation system including: a simulation digital storage medium including lidar data from a lidar sensor and a three-dimensional model of at least one object, wherein the lidar data includes an origin and a point cloud; and a controller in communication with the simulation digital storage medium, the controller: retrieves the lidar data and the model from the simulation digital storage medium; superimposes the model in the lidar data; traces a beam line from the origin to each point in the point cloud, each beam line collinear with a beam trajectory of a lidar beam which generated the respective point in the lidar data; identifies intersecting beam lines, defined as beam lines which intersect the model; and moves the respective point for each intersecting beam line to a surface of the model closest to the origin along the intersecting beam line to generate a validation point cloud including original points and moved points.

In some examples, a simulation system, wherein the three-dimensional model of the object is a stereolithography (STL) model.

In some examples, a simulation system, wherein the three-dimensional model of the object is based on lidar data of the object.

In some examples, a simulation system, wherein the controller adds noise to at least some of the moved points.

In some examples, a simulation system, wherein the controller determines an average noise from the lidar data, and adds a corresponding average noise to the moved points.

In some examples, a simulation system, wherein the controller further moves at least some points on the intersecting beams closer to, or further from, the origin than the surface of the model, to introduce false positives and/or adds at least some false points anywhere along the intersecting beam lines to introduce false positives.

A validation system for validating a processing algorithm for lidar data is disclosed. The validation system including: a simulation system including: a simulation digital storage medium including lidar data from a lidar sensor and a three-dimensional model of at least one object, wherein the lidar data includes an origin and a point cloud; and a controller in communication with the simulation digital storage medium, the controller: retrieves the lidar data and the model from the simulation digital storage medium; superimposes the model in the lidar data; traces a beam line from the origin to each point in the point cloud, each beam line collinear with a beam trajectory of a lidar beam which generated the respective point in the lidar data; identifies intersecting beam lines, defined as beam lines which intersect the model; and moves the respective point for each intersecting beam line to a surface of the model closest to the origin along the intersecting beam line to generate a validation point cloud including original points and moved points; a validation digital storage medium for storing at least one validation point cloud from the simulation system and a corresponding object label for each model which was superimposed into the lidar data; a controller in communication with the validation digital storage medium, the controller: executes a lidar processing algorithm on the at least one validation point cloud, the lidar processing algorithm applying a label to each object identified in the respective at least one validation point cloud; and validates the processing algorithm if each label applied by the processing algorithm to the object in the at least one validation point cloud matches the corresponding object labels in the validation digital storage medium.

In some examples, a validation system, wherein the validation digital storage medium stores at least two validation point clouds and corresponding object labels, and wherein the controller: executes the lidar processing algorithm on the at least two validation point clouds, the lidar processing algorithm labelling objects found in the respective at least two validation point clouds, and validates the processing algorithm if the label applied by the processing algorithm for each and every validation point cloud matches each and every corresponding object label in the digital storage medium.

In some examples, a method including: retrieving lidar data and a three-dimensional model of an object from a simulation digital storage medium, wherein the lidar data is obtained from a lidar sensor and includes an origin and a point cloud; superimposing the model in the lidar data; tracing a beam line from the origin to each point in the point cloud, each beam line collinear with a beam trajectory of a lidar beam which generated the respective point in the lidar data; identifying intersecting beam lines, defined as beam lines which intersect the model; and moving the respective point for each intersecting beam line to a surface of the model closest to the origin along the intersecting beam to generate a validation point cloud including original points and moved points.

In some examples, a method, wherein the three-dimensional model of the object is a stereolithography (STL) model.

In some examples, a method, wherein the three-dimensional model of the object is based on lidar data of the object.

In some examples, a method, further including generating the three-dimensional model of the object by: receiving lidar data of a scene including the object; cropping object lidar points from other lidar points, the object lidar points defined as the points in the lidar data relating to the object; adding a mesh to the object lidar points to define a surface of the object.

In some examples, a method, wherein the three-dimensional model defines at least a surface of the object.

In some examples, a method, further including, after moving the respective points, adding noise to at least some of the moved points to generate the validation point cloud.

In some examples, a method, determining an average noise from the lidar data and adding a corresponding average noise to the moved points.

In some examples, a method, further including moving at least some of the points on the intersecting beams closer to, or further from, the origin than the surface of the model, to introduce false positives to generate the validation point cloud and/or adding at least some false points anywhere along the intersecting beam lines to introduce false positives.

In some examples, a method, further include receiving an object label relating to the model; executing a lidar processing algorithm on the validation point cloud, the lidar processing algorithm applying a label to each object identified in the respective at least one validation point cloud; and validating the processing algorithm if the label applied by the processing algorithm to the object in the at least one validation point cloud matches the corresponding object label.

In some examples, a method, including generating at least two validation point clouds, each validation point cloud using a different model and/or the same model in a different location or orientation.

In some examples, a method, including generating at least two validation point clouds, each validation point cloud using a different model and/or the same model in a different location or orientation; receiving an object label for each model; executing the lidar processing algorithm on each validation point cloud, the lidar processing algorithm applying labels to objects identified in the respective validation point cloud; and validating the processing algorithm if the labels applied by the processing algorithm to the objects for each and every validation point cloud matches the object labels for each and every corresponding models in the respective validation point cloud.

The various examples described in the summary and this document are provided not to limit or define the disclosure or the scope of the claims.

### BRIEF DESCRIPTION OF THE FIGURES

FIG. 1 is a side view of an autonomous yard truck according to some embodiments.

FIG. 2. illustrates a block diagram of an example simulation system and validation system of the present disclosure.

FIG. 3 is a flow chart showing steps of a method of generating a validation point cloud.

FIG. 4 illustrates a simplified point cloud from a LiDAR sensor with steps for generating the validation point cloud of FIG. 3.

FIG. 5 illustrates an example validation point cloud.

FIG. 6 is a flow chart showing steps of a method of validating a LiDAR processing system with a validation point cloud.

FIG. 7 is a flow chart showing steps of a method of creating an object model for generating a validation point cloud.

FIG. 8 is a block diagram of an example computational system (or controller).

### DETAILED DESCRIPTION

Systems and/or methods are disclosed for generating validation point clouds and for validating LiDAR processing algorithms.

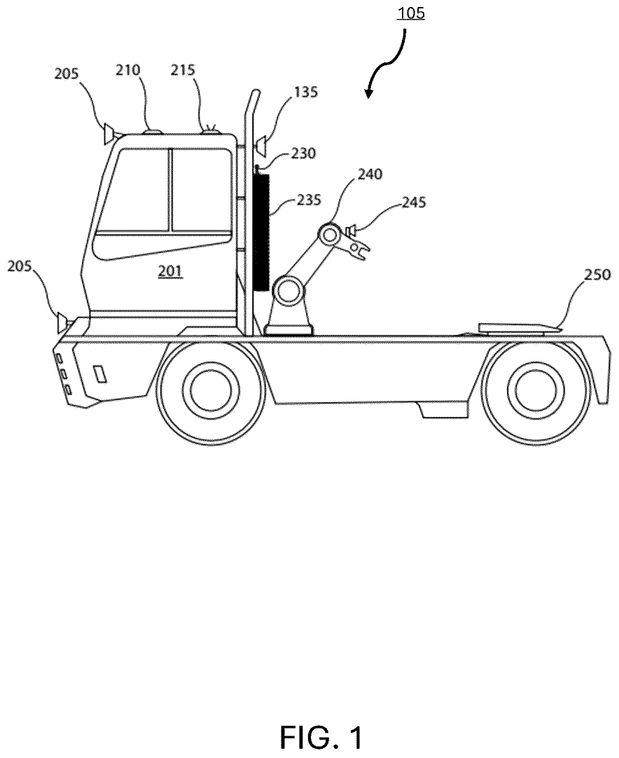

FIG. 1 is a side view of an autonomous yard truck 105 according to some embodiments. The autonomous yard truck 105 includes a cab 201 that may be used to drive the autonomous yard truck 105 manually. The autonomous yard truck 105 may include one or more controllers as shown in FIG. 1. The autonomous yard truck 105 may also include a brake system, an engine, a transmission, steering, etc.

In some embodiments, the autonomous yard truck 105 may include a sensor array that includes sensors 205 disposed at various locations on the autonomous yard truck 105 such as, for example, on the cab 201, bumper, housing, frame, etc. The sensors 205 may include infrared sensors, ultrasonic sensors, magnetic sensors, radar sensors, LiDAR sensors, terahertz sensors, sonar sensors, cameras, etc. The autonomous yard truck 105 may also include one or more backup sensors 135 such as, for example, infrared sensors, ultrasonic sensors, magnetic sensors, radar sensors, LiDAR sensors, terahertz sensors, sonar sensors, cameras, etc. The sensors 205, such as LiDAR sensors, may be used to identify objects in real time during autonomous movement of the autonomous yard truck 105. It is therefore important for any processing algorithm, such as a LiDAR processing algorithm, to be rigorously tested and validated to ensure that it will accurately identify objects in use.

In some embodiments, the autonomous yard truck 105 may include a spatial locating device (or GPS) antenna 210. In some embodiments, the autonomous yard truck 105 may include a transceiver antenna 215.

In some embodiments, the autonomous yard truck 105 may include one or more hoses 235 that can be connected with the trailer 260 such as, for example, two or three hoses. Each hose may have a hose connector 230 that can be connected with a trailer hose connector 265. For example, the autonomous yard truck 105 may include a service brake hose, an emergency brake hose, and/or a refrigerant hose.

In some embodiments, the autonomous yard truck 105 may include a robotic arm 240 disposed on the back bed of the autonomous yard truck 105. The robotic arm 240 may include any type of robotic arm. The robotic arm 240, for example, may exert high torque or high pressure sufficient to connect the hose connector 230 with the trailer hose connector 265. The hose connector 230 and/or the trailer hose connector 265 may comprise a glad-hand connector. In some embodiments, when the autonomous yard truck 105 is not coupled with a trailer 260, the hose connector 230 may be positioned in a storage rack at some point on the autonomous yard truck 105 such as, for example, on the rear of the cab 201.

In some embodiments, the robotic arm 240 may include one or more arm sensors 245 such as, for example, infrared sensors, ultrasonic sensors, magnetic sensors, radar sensors, LiDAR sensors, terahertz sensors, sonar sensors, cameras, etc. The arm sensor 245, for example, may produce data that can be used to identify the location of a hose connector 230 and/or a trailer hose connector 265. The arm sensor 245, for example, may produce data that can show that a hose connector 230 and/or a trailer hose connector 265 are sufficiently coupled.

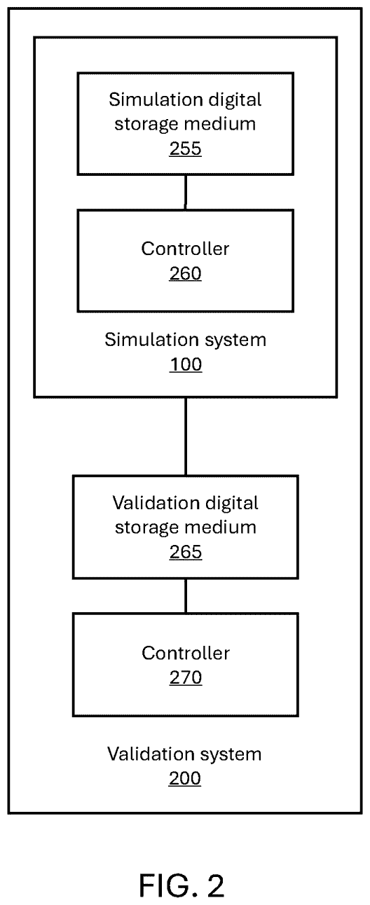

In some embodiments, the autonomous yard truck 105 may include a fifth-wheel coupling 250. The fifth-wheel coupling 250, for example, may be raised or lowered with a fifth-wheel coupling boom. FIG. 2 shows the fifth-wheel coupling 250 in a lowered position. The fifth-wheel coupling 250 may couple with a kingpin 255 of a trailer 260.

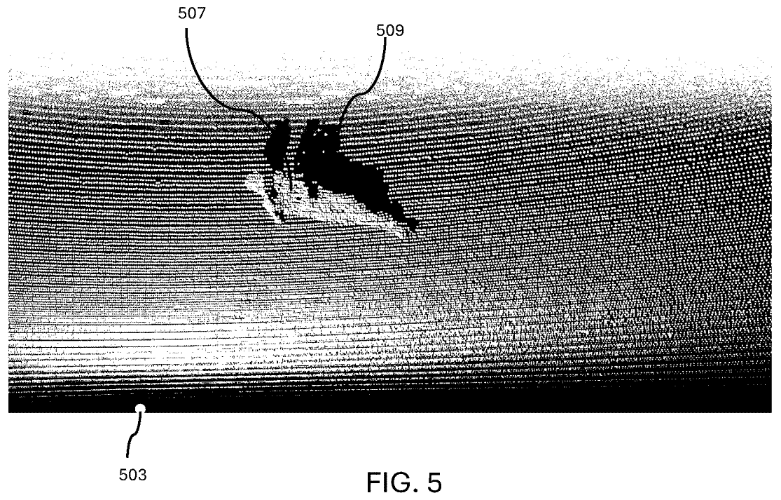

When the fifth-wheel coupling 250 is coupled with a kingpin 255 and the fifth-wheel coupling 250 is in the raised fifth-wheel coupling 250 position, the trailer legs 270 may lifted off the ground as shown in FIG. 5. This may allow the autonomous yard truck 105 to pull the trailer 260 without individually raising the trailer legs 270.

In some embodiments, the robotic arm 240 and/or the arm sensor 245 may be coupled with a thermal management system. A thermal management system may, for example, be coupled with a thermal management system associated with the autonomous yard truck 105 such as, for example, coupled with the cab heating/cooling system and/or the engine heating/cooling system. A thermal management system may, for example, be an independent system that heats and/or cools the robotic arm 240 and/or the arm sensor 245. A thermal management system may, for example, keep the temperature of the robotic arm 240 and/or the arm sensor 245 between about 32° F. and about 100° F.

In some embodiments, the autonomous yard truck 105 may include a deployable shade coupled with the back of the cab 201. The deployable shade, for example, may be used to screen the sun and/or other lighting from the arm sensor 245 and/or the one or more backup sensors 135. The deployable shade, for example, may include an umbrella configuration or an awning configuration. The deployable shade, for example, may be coupled with the roof or an upper portion of the cab.

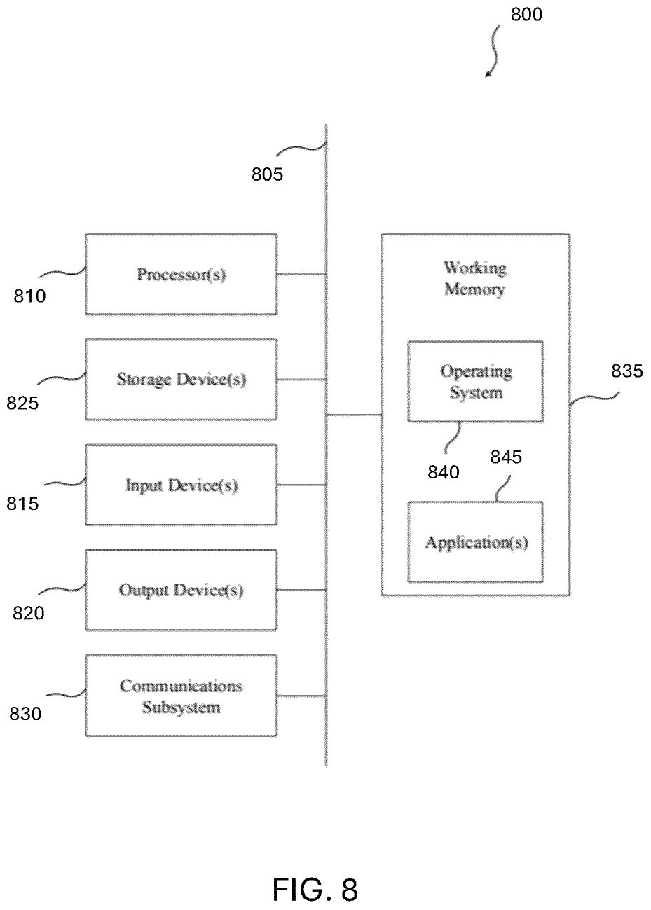

FIG. 2 shows a block diagram of an example simulation system 100 and validation system 200 of the present disclosure. The validation system 200 comprises the simulation system 100 in this example. The simulation system 100 comprises, in this example, a simulation digital storage medium 255 and a controller 260. The simulation system 100 may include any or all components of computational unit 800 shown in FIG. 8.

In this example, the simulation digital storage medium 255 comprises, in other words stores, LiDAR data from a LiDAR sensor, for example a LiDAR sensor 205 on the autonomous yard truck 105. The LiDAR data may include a static snapshot of LiDAR data or a moving “video” of continuous LiDAR data. The LiDAR data may include an origin and a point cloud comprising a plurality of LiDAR points. For example, the position of the LiDAR points may be defined with reference to the origin. The origin may represent the point at which LiDAR beams were emitted when the LiDAR data was collected from the LiDAR sensor.

In this example, the simulation digital storage medium 255 also comprises a three-dimensional model of at least one object. The model may be a stereolithography (STL) model. Each object may be accompanied by a corresponding object label denoting what the object is.

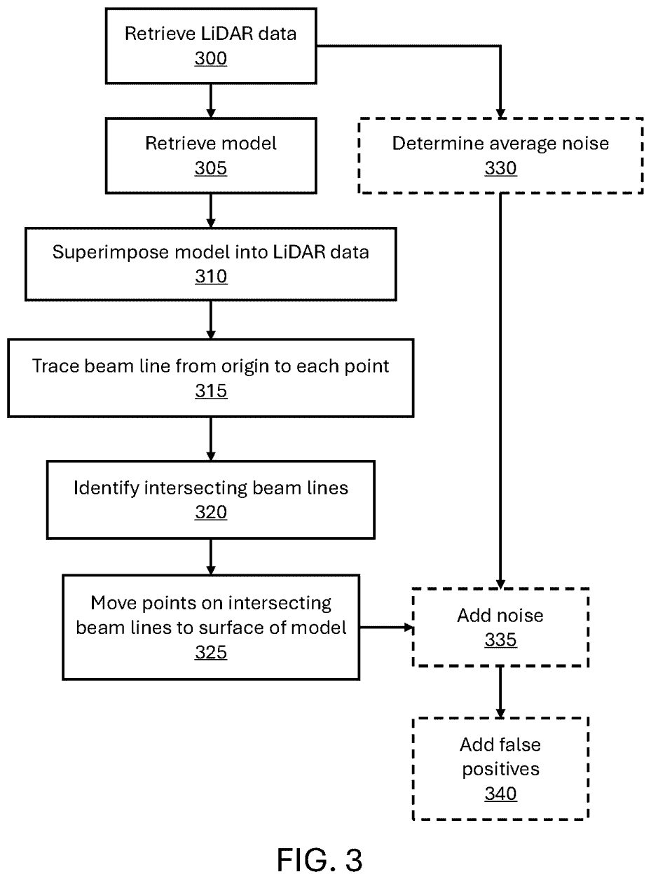

The simulation digital storage medium 255 may also comprise a validation point cloud algorithm which is a computer executable program for generating a validation point cloud. The method executed by the validation point cloud algorithm is described with reference to FIG. 3. Broadly, the validation point cloud algorithm superimposes at least one model of an object into the LiDAR data, and modifies the point cloud based on the superimposed model to generate the validation point cloud. The validation point cloud is a mix of real and simulated LiDAR data, and includes a point cloud which represents the points that a LiDAR sensor would have captured if the object had been located in the field of view of the LiDAR sensor when the LiDAR data was captured.

In this example, the simulation system 100 comprises a controller 260 which is in communication with the simulation digital storage medium 255. The controller 260, in this example, executes the validation point cloud algorithm, and outputs a validation point cloud for use by the validation system 200 to validate LiDAR processing algorithms.

In this example, the validation system 200 comprises a validation digital storage medium 265 which is separate from the simulation digital storage system 255. The validation digital storage medium 265 is, in this example, in communication with the simulation system 100. In this example, the validation digital storage medium 265 comprises (i.e., stores) the validation point clouds generated by the simulation system 100 in a validation point cloud database. The validation digital storage medium 265 may store a plurality of different validation point clouds in the validation point cloud database. Each validation point cloud may be accompanied by a corresponding object label for each model which was superimposed into the respective LiDAR data. For example, where only a single model is superimposed into the LiDAR data, the validation point cloud may be accompanied by an object label representing that model. In examples where more than one of the same model is superimposed into the LiDAR data, there may be one object label accompanying the validation point cloud, representing all of the superimposed models, or there may be more than one of the same object label, with each object label tagged to each superimposed model. In examples where more than one different model is superimposed into the LiDAR data, there may be more than one different object label, with each object label tagged to the relevant superimposed model in the LiDAR data.

The validation digital storage medium 265, in this example, stores at least one LiDAR processing algorithm to be tested. The validation digital storage medium 265 may also store a validation algorithm for validating the stored LiDAR processing algorithms. Instructions of the validation algorithm may comprise initiating execution of the LiDAR processing algorithms.

In this example, the validation system 200 also comprises a controller 270 which is in communication with the validation digital storage medium 265. The controller 270, in this example, executes the validation algorithm and/or the LiDAR processing algorithms stored in the validation digital storage medium 265. The validation system 200 may include any or all components of computational unit 800 shown in FIG. 8.

In other examples, the simulation digital storage system 255 and the validation digital storage system 265 may be unitary. In other words, a single digital storage medium may store all of the information that the simulation digital storage medium 255 and the validation digital storage medium 265 store.

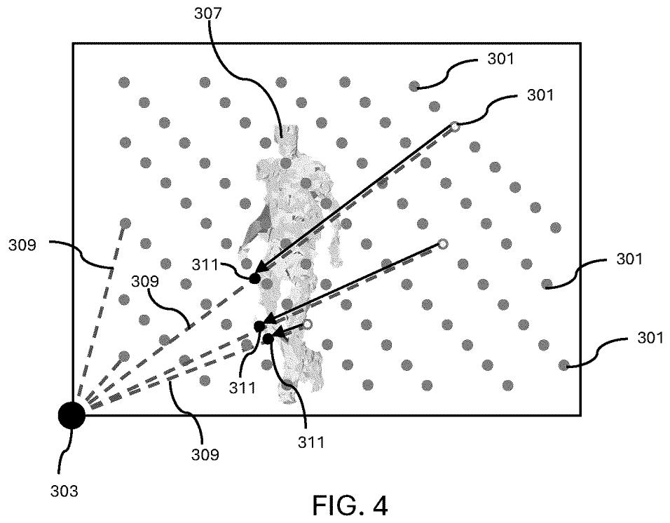

FIG. 3 is a flow chart showing steps of a method of generating a validation point cloud (e.g., step executed by the validation point cloud algorithm described with reference to FIG. 2). The method described with reference to the flow chart of FIG. 3 is therefore executed by the controller 260 of the simulation system 100. FIG. 4 shows a simplified point cloud with steps of the method of FIG. 3 illustrated, and FIG. 5 shows an example validation point cloud generated by the method.

In block 300, the method comprises retrieving the LiDAR data from the simulation digital storage medium 255. The LiDAR data comprises a point cloud comprising a plurality of points 301 (only four points have been numbered in FIG. 3 for clarity). The LiDAR data in this example is a static snapshot of data which has been captured by a LiDAR sensor. The LiDAR data also comprises an origin 303.

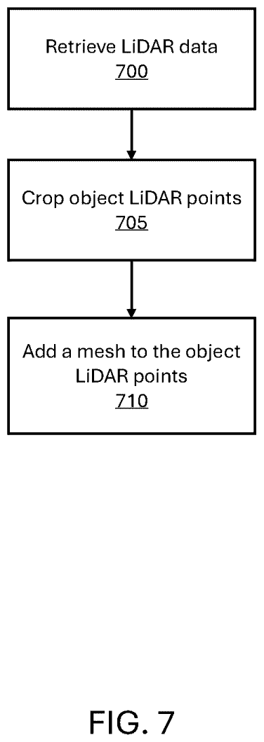

In block 305, the method comprises retrieving a model 307 from the simulation digital storage medium. It will be appreciated that blocks 300 and 305 may be completed simultaneously, or in any suitable order. The model 307 may be a stereolithography (STL) model. In some examples, the model 307 may be based on LiDAR data, as described with reference to FIG. 7. In other examples, the model 307 may be a simple CAD file defining at least the surface of an object.

In block 310, the method comprises superimposing the model 307 in the LiDAR data. The model may be moved into any position and/or orientation within the LiDAR data and may be made into any size. The model may be automatically positioned, sized and/or oriented in the LiDAR data, or may be positioned, sized and/or oriented in the LiDAR data manually by a user.

In block 315, the method comprises tracing a beam line 309 (shown as dashed lines in FIG. 3) from the origin to each point 301 in the point cloud of the LiDAR data. Only five beam lines are shown in FIG. 4 for clarity. In this example, at one end the beam line stops at the origin and at the other end, the beam line stops at a respective point. This generates a plurality of beam lines corresponding to the number of points in the point cloud, with each beam line being collinear with a beam trajectory of a LiDAR beam from a LiDAR sensor which generated the respective point in the LiDAR data. It will be appreciated that block 315 may be carried out before blocks 305 and 310, or at the same time as blocks 305 and 310.

In block 320, the method comprises identifying intersecting beam lines 309, which are the beam lines 309 which intersect the model 307.

In block 325, the method comprises, for each intersecting beam line 309, moving the respective point on the intersecting beam line 309 to a surface of the model 307 closest to the origin 303 along the intersecting beam line 309 so that it is now a moved point 311 (shown by an arrow in FIG. 4.). Although it has been described as moving the point, it will be appreciated that this covers the original point 301 being deleted and a new moved point 311 being added on the beam line 309 at the surface of the model 307 closest to the origin 303. The original point 301 on each intersecting beam line 309 is therefore no longer in the point cloud, and has been replaced by a moved point 311 to generate the validation point cloud. The validation point cloud therefore comprises original points 301 (on beam lines 309 which did not intersect the model 307) and moved points 311 (on intersecting beam lines 309).

Replacing the original points 301 from intersecting beam lines 309 with moved points 311, as described above, ensures that the correct point density is maintained for the validation point cloud to realistically model the LiDAR data that would be generated if the object modelled by the model 307 had really been in the scene captured by the LiDAR sensor. Moving only the points 301 on intersecting beam lines 309 also ensures that any points 301 in the point cloud which are in front of the model 307 (when viewed from the origin 303) are not moved. For example, if the point cloud from the LiDAR sensor captured a scene in snowy or dusty weather, many points would be captured in front of the model 307 compared to LiDAR data captured on a clear day. A LiDAR processing algorithm will need to be able to identify objects even in poor conditions, so retaining the poor conditions in the data in this manner provides a realistic point cloud for use in testing the LiDAR processing algorithm.

In block 330, the method comprises determining an average noise from the LiDAR data of block 300. For example, a local neighborhood of points in three-dimensions may be analyzed at various locations in the point cloud. The points in the local neighborhood may be fit to a plane, and the noise distribution of points around the plane may be analyzed, including for example, mean and standard deviation for a Gaussian distribution. The local neighborhood's range, reflectivity, and/or incident angle may also be determined. This may be repeated for multiple neighborhoods in the point cloud. The multiple neighborhoods may be adjacent and contiguous. The multiple neighborhoods may be adjacent and overlapping, with some points being in multiple neighborhoods. The average noise, the range, the reflectivity and/or the incident angle for each neighborhood may be stored in the simulation digital storage medium 255, and may be associated with the LiDAR data.

In block 335, the method comprises adding noise to the validation point cloud generated in block 325. In some examples, noise may be added by moving any of the original points 301 or the moved points 311 in the validation point cloud. In other examples, noise may be added by moving only the moved points 311 in the validation point cloud. For example, a software random number generator may be used, based on the average noise determined in block 330 (i.e., the mean and standard deviation for a Gaussian distribution determined in block 330), to determine how much any of the moved points 311 should be further moved.

In block 340, the method comprises adding false positives to the validation point cloud from block 335, or to the validation point cloud from block 325 if blocks 330 and 335 are omitted. For example, a predetermined percentage of the moved points 311 may be moved so that they are not on the surface of the model 307 closest to the origin 303 (i.e., they may be moved along the intersecting beam line 309 closer to, or further from, the origin 303). They may be moved to appear in front of, or behind, the surface of the model 307. In some examples, multiple false positives may be introduced along a single intersecting beam line 309. In some examples, one of the points on an intersecting beam line 309 may be on the surface of the model 307 closest to the origin 303, with further false points added at any point along the intersecting beam line 309.

In some examples, blocks 330, 335 and/or 340 may be omitted. In some examples, block 330 may be carried out separately from this method and may be provided as metadata with the LiDAR data which is retrieved in block 300.

FIG. 5 shows an example of a validation point cloud after a model 507 of a person lying down was superimposed into a point cloud generated from a LiDAR sensor sensing a flat surface from an origin 503. The original points of the intersecting beam lines have been moved to the surface of the model 507 so that the profile of the model 507 can be seen in the validation point cloud and so that a shadow 509 is formed behind the model 507.

This method may be repeated with the same model in different orientations and positions in the scene or with different models. The method may also comprise superimposing more than one model into the scene. The simulation system 100 can therefore generate many iterations of realistic simulated LiDAR data from a single snapshot of real LiDAR data and one or more models of objects.

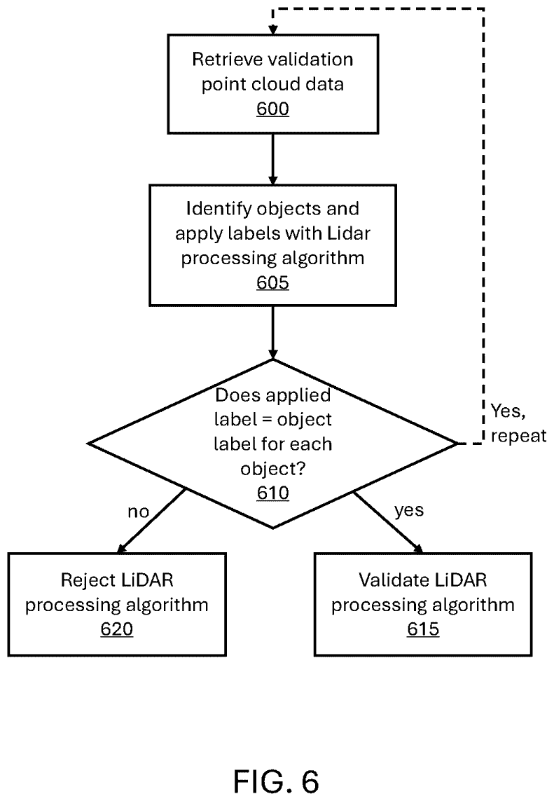

FIG. 6 is a flow chart showing steps of a method of validating a LiDAR processing system. The method described with reference to the flow chart of FIG. 6 is therefore executed by the controller 270 of the validation system 200.

In block 600, the method comprises retrieving validation point cloud data from the validation digital storage medium 265. The validation point cloud data includes, in this example, a validation point cloud and at least one corresponding object label relating to each model that was superimposed into LiDAR data to generate the respective validation point cloud.

In block 605, the method comprises executing the LiDAR processing algorithm to be validated, to identify objects in the validation point cloud, and to apply labels to the each of the objects identified in the validation point cloud by the LiDAR processing algorithm. Blocks 600, 605, and 610 may be repeated for more than one set of validation point cloud data, so that the output of block 605 to block 610 is multiple sets of validation point cloud data including validation points clouds, each of which has had objects within the validation point cloud identified and labelled. Each set of validation point cloud data may be retrieved from the validation digital storage medium.

In block 610, the method comprises determining whether the labels applied to the objects in block 605 match the object labels of the models associated with the respective validation point cloud. If any applied labels to identified objects do not match the corresponding object label, the method proceeds to block 620. For example, if the object label is different to the applied label, the method proceeds to block 620. In another example, if there is no object label associated with the location in the validation data at which an object was identified, or if there is no object identified in block 605 where the object label is tagged, the method may proceed to block 620.

If the applied labels match the corresponding object labels from the validation point cloud data retrieved in block 600, then the method may either proceeds to block 615 or the method may return to block 600 to repeat blocks 600, 605 and 610 with a different set of validation point cloud data. Where the method requires multiple sets of validation point cloud data to be processed, the method returns to block 600 from block 610 until the last set of validation point cloud data, and then, if the applied labels match the corresponding object labels for the last set of validation point cloud data, the method proceeds to block 615. Therefore, in examples where blocks 600, 605 and 610 are iterated with multiple sets of validation point cloud data, the method only proceeds to block 615 if each and every applied label matches the each and every corresponding object label in each and every set of validation point cloud data.

In block 615, the method comprises validating the LiDAR processing algorithm as it has been shown to have identified the objects correctly in the validation point cloud. The whole method may be repeated again for a different set of validation point cloud data, or multiple sets of validation point cloud data may be retrieved and processed in blocks 600, 605 and 610 before proceeding to block 615.

In block 620, the method comprises rejecting the LiDAR processing algorithm. When the method has proceeded to block 620, an error has been identified in the output of the LiDAR processing algorithm. For example, at least one label applied to an identified object in block 605 has been found to be incorrect, or the LiDAR processing algorithm has failed to identify at least one object in the validation point cloud. The error may be output to a user interface, so that it can be analyzed by a user. For example, the user interface may show the validation data, the identified object in the validation data, such as the location within the validation data where an object has been identified, the actual location of the object within the validation point cloud, the applied label to the identified object and/or the object label of the actual object.

FIG. 7 is a flow chart showing steps of a method of creating a three-dimensional model of an object for use in the simulation system 100. In this example, the model is based on LiDAR data of an object.

In block 700, the method comprises retrieving LiDAR data of a scene including an object. The LiDAR data may be collected from a LiDAR sensor which had a known object in its field of view, and may comprise a point cloud.

In block 705, the method comprises cropping object LiDAR points in the point cloud, relating to the known object in the scene, from other LiDAR points in the point cloud, which are not related to the object.

In block 710, the method comprises adding a mesh to the object LiDAR points to define a surface of the object. A maximum edge length of the mesh may be based on the point density of the object LiDAR points. For example, the maximum edge length of the mesh may be larger than the average distance between the object LiDAR points.

The computational system 800, shown in FIG. 8 can be used to perform any of the examples disclosed in this document. For example, computational system 800 can be used to execute processes described with reference to FIGS. 3, 6 and 7. As another example, computational system 800 can perform any calculation, identification and/or determination described here. Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 830 may permit data to be exchanged with a network (such as the network described below, to name one example), and/or any other devices described in this document. The computational system 800, for example, may include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

The storage medium, for example, might be incorporated within the computational system 800 or in communication with the computational system 800. The storage medium might be separate from a computational system 800 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Although term “autonomous vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

That which is claimed:

1. A simulation system for generating a validation point cloud for validating a lidar processing algorithm, the simulation system comprising:
a simulation digital storage medium comprising lidar data from a lidar sensor and a three-dimensional model of at least one object, wherein the lidar data comprises an origin and a point cloud; and
a controller in communication with the simulation digital storage medium, the controller:
retrieves the lidar data and the model from the simulation digital storage medium;
superimposes the model in the lidar data;
traces a beam line from the origin to each point in the point cloud, each beam line collinear with a beam trajectory of a lidar beam which generated the respective point in the lidar data;
identifies intersecting beam lines, defined as beam lines which intersect the model; and
moves the respective point for each intersecting beam line to a surface of the model closest to the origin along the intersecting beam line to generate a validation point cloud comprising original points and moved points.

2. The simulation system according to claim 1, wherein the three-dimensional model of the object is a stereolithography (STL) model.

3. The simulation system according to claim 1, wherein the three-dimensional model of the object is based on lidar data of the object.

4. The simulation system according to claim 1, wherein the controller adds noise to at least some of the moved points.

5. The simulation system according to claim 4, wherein the controller determines an average noise from the lidar data, and adds a corresponding average noise to the moved points.

6. The simulation system according to claim 1, wherein the controller further moves at least some points on the intersecting beams closer to, or further from, the origin than the surface of the model, to introduce false positives and/or adds at least some false points anywhere along the intersecting beam lines to introduce false positives.

7. A validation system for validating a processing algorithm for lidar data, the validation system comprising:
a simulation system comprising:
a simulation digital storage medium comprising lidar data from a lidar sensor and a three-dimensional model of at least one object, wherein the lidar data comprises an origin and a point cloud; and
a controller in communication with the simulation digital storage medium, the controller:
retrieves the lidar data and the model from the simulation digital storage medium;
superimposes the model in the lidar data;
traces a beam line from the origin to each point in the point cloud, each beam line collinear with a beam trajectory of a lidar beam which generated the respective point in the lidar data;
identifies intersecting beam lines, defined as beam lines which intersect the model; and
moves the respective point for each intersecting beam line to a surface of the model closest to the origin along the intersecting beam line to generate a validation point cloud comprising original points and moved points;
a validation digital storage medium for storing at least one validation point cloud from the simulation system and a corresponding object label for each model which was superimposed into the lidar data;
a controller in communication with the validation digital storage medium, the controller:
executes a lidar processing algorithm on the at least one validation point cloud, the lidar processing algorithm applying a label to each object identified in the respective at least one validation point cloud; and
validates the processing algorithm if each label applied by the processing algorithm to the object in the at least one validation point cloud matches the corresponding object labels in the validation digital storage medium.

8. The validation system according to claim 7, wherein the validation digital storage medium stores at least two validation point clouds and corresponding object labels, and wherein the controller:
executes the lidar processing algorithm on the at least two validation point clouds, the lidar processing algorithm labelling objects found in the respective at least two validation point clouds, and
validates the processing algorithm if the label applied by the processing algorithm for each and every validation point cloud matches each and every corresponding object label in the digital storage medium.

9. A method comprising:
retrieving lidar data and a three-dimensional model of an object from a simulation digital storage medium, wherein the lidar data is obtained from a lidar sensor and comprises an origin and a point cloud;
superimposing the model in the lidar data;
tracing a beam line from the origin to each point in the point cloud, each beam line collinear with a beam trajectory of a lidar beam which generated the respective point in the lidar data;
identifying intersecting beam lines, defined as beam lines which intersect the model; and
moving the respective point for each intersecting beam line to a surface of the model closest to the origin along the intersecting beam to generate a validation point cloud comprising original points and moved points.

10. The method according to claim 9, wherein the three-dimensional model of the object is a stereolithography (STL) model.

11. The method according to claim 9, wherein the three-dimensional model of the object is based on lidar data of the object.

12. The method according to claim 11, further comprising generating the three-dimensional model of the object by:
receiving lidar data of a scene including the object;
cropping object lidar points from other lidar points, the object lidar points defined as the points in the lidar data relating to the object;
adding a mesh to the object lidar points to define a surface of the object.

13. The method according to claim 9, wherein the three-dimensional model defines at least a surface of the object.

14. The method according to claim 9, further comprising, after moving the respective points, adding noise to at least some of the moved points to generate the validation point cloud.

15. The method according to claim 14, determining an average noise from the lidar data and adding a corresponding average noise to the moved points.

16. The method according to claim 9, further comprising moving at least some of the points on the intersecting beams closer to, or further from, the origin than the surface of the model, to introduce false positives to generate the validation point cloud and/or adding at least some false points anywhere along the intersecting beam lines to introduce false positives.

17. The method according to claim 9, further comprising:
receiving an object label relating to the model;
executing a lidar processing algorithm on the validation point cloud, the lidar processing algorithm applying a label to each object identified in the respective at least one validation point cloud; and
validating the processing algorithm if the label applied by the processing algorithm to the object in the at least one validation point cloud matches the corresponding object label.

18. The method according to claim 9, comprising generating at least two validation point clouds, each validation point cloud using a different model and/or the same model in a different location or orientation.

19. The method according to claim 17, comprising generating at least two validation point clouds, each validation point cloud using a different model and/or the same model in a different location or orientation;
receiving an object label for each model;
executing the lidar processing algorithm on each validation point cloud, the lidar processing algorithm applying labels to objects identified in the respective validation point cloud; and
validating the processing algorithm if the labels applied by the processing algorithm to the objects for each and every validation point cloud matches the object labels for each and every corresponding models in the respective validation point cloud.
